(19) United States
(12) Patent Application Publication
(10) Pub. No.: US 2025/0045937 A1
(43) Pub. Date: Feb. 6, 2025

(54) IMAGE REGISTRATION METHOD, SYSTEM, DEVICE, AND MEDIUM

(71) Applicant: Shanghai United Imaging Healthcare Co., Ltd., Shanghai (CN)

(72) Inventors: Chen Sun, Shanghai (CN); Yihuan Lu, Shanghai (CN); Hancong Xu, Shanghai (CN); Yun Dong, Shanghai (CN)

(21) Appl. No.: 18/789,644

(22) Filed: Jul. 30, 2024

(30) Foreign Application Priority Data
Jul. 31, 2023 (CN) 202310955662.3

(51) Int. Cl. G06T 7/30; G06T 5/70; G06T 7/12; G06T 11/00

(52) U.S. Cl. CPC G06T 7/30; G06T 5/70; G06T 7/12; G06T 11/005; G06T 11/006; G06T 2207/10104

(57) ABSTRACT

An image registration method, a system, a device, and a medium are provided. The image registration method includes acquiring a to-be-registered image and a reference image of an object, performing registration on the to-be-registered image and the reference image. Either or both of the to-be-registered image and the reference image is a Histoimage with a PET mode.

### CROSS-REFERENCE TO RELATED APPLICATION

This application claims priority to Chinese patent application No. 202310955662.3, filed on Jul. 31, 2023, titled “IMAGE REGISTRATION METHOD, SYSTEM, DEVICE, AND MEDIUM”, the content of which is hereby incorporated by reference in its entirety.

### TECHNICAL FIELD

The present disclosure generally relates to the field of image processing, and in particular, to an image registration method, a system, a device, and a medium.

### BACKGROUND

Image registration is a basic tool in medical image analysis, and widely used in fields such as mode fusion, pathology analysis and diagnosis, and computer-assisted surgeries. Image registration generally involves two images, i.e., a reference image (a fixed image) and a moving image (to-be-registered image). Image registration is a process in which two images with different or same modes are spatially matched. An obtained result is a spatial transformation relationship in which the moving image is registered to the reference image, a target of the registration is to acquire a deformation field or other parameters describing a relative motion, so as to determine a position of each voxel corresponding to the reference image in the moving image.

In a conventional image registration of a PET (Positron Emission Computed Tomography) mode, to obtain a PET image with superior anatomical structure information, a reconstructed image needs to be obtained first. Specifically, raw data of PET which is directly collected is processed as a reconstructed image by methods such as FBP (Filtered back projection) or OSEM (Ordered Subsets Expectation Maximization). After the reconstructed image is obtained, a registration process between the moving image and the reference image is performed. Because a process of image reconstruction leads to excessive time and calculation overheads, an application of this technology in a time-sensitive scenario is limited. In addition, after the reconstructed image is obtained, time spent on the registration is generally less than time of reconstruction, and excessive time and calculation thresholds reduce practicality of the image registration.

### SUMMARY

According to various embodiments of the present disclosure, an image registration method, a system, a device, and a medium are provided.

In a first aspect, an image registration method based on a Histoimage (a back-projection image) is provided, and the image registration method includes: acquiring a to-be-registered image and a reference image of an object, performing registration on the to-be-registered image and the reference image. Either or both of the to-be-registered image and the reference image is a Histoimage with a Positron Emission Computed Tomography (PET) mode.

In some embodiments, acquiring the to-be-registered image and the reference image of the object further includes: acquiring raw data corresponding to the object in a PET scanning process, generating, based on the raw data, a target Histoimage corresponding to the object, and taking the target Histoimage as the to-be-registered image or the reference image.

In some embodiments, generating, based on the raw data, the target Histoimage corresponding to the object further includes: generating, based on the raw data, an initial Histoimage corresponding to the object, and preprocessing the initial Histoimage to generate the target Histoimage. The preprocessing includes either or both of correction and denoising.

In some embodiments, preprocessing the initial Histoimage to generate the target Histoimage further includes: performing the correction on the initial Histoimage to generate the target Histoimage. The correction includes at least one of a scattering correction, an attenuation correction, a sensitivity correction, or a random correction.

In some embodiments, generating, based on the raw data, the initial Histoimage corresponding to the object further includes: acquiring annihilation events corresponding to the raw data, and performing a back-projection operation on the annihilation events to generate the initial Histoimage.

In some embodiments, preprocessing the initial Histoimage to generate the target Histoimage further includes: denoising the initial Histoimage by a deep learning network or an image filter. The deep learning network includes a denoising network or a generation network from a Histoimage to a reconstructed image with Ordered

### Subsets Expectation Maximization.

In some embodiments, performing registration on the to-be-registered image and the reference image further includes: performing image segmentation on the to-be-registered image and the reference image, performing image registration on a to-be-registered image obtained after the image segmentation and a reference image obtained after the image segmentation, and generating a deformation field in which the to-be-registered image is registered with the reference image.

In some embodiments, performing image segmentation on the to-be-registered image and the reference image, performing image registration on the to-be-registered image obtained after the image segmentation and the reference image obtained after the image segmentation, and generating the deformation field in which the to-be-registered image is registered with the reference image further includes: performing image segmentation on the to-be-registered image and the reference image based on a preset segmentation algorithm, obtaining a first image corresponding to the to-be-registered image and a second image corresponding to the reference image, performing registration between the first image and the second image based on a preset registration algorithm, and generating the deformation field in which the to-be-registered image is registered with the reference image.

In some embodiments, performing image segmentation on the to-be-registered image and the reference image based on the preset segmentation algorithm, and obtaining the first image corresponding to the to-be-registered image and the second image corresponding to the reference image further includes: segmenting at least one of a head, an upper arm, a lower arm, a thigh, or a lower leg from the to-be-registered image and the reference image, respectively. The first image and the second image include at least one of a corresponding head, a corresponding upper arm, a corresponding lower arm, a corresponding thigh, or a corresponding lower leg, respectively.

In some embodiments, performing image segmentation on the to-be-registered image and the reference image based on the preset segmentation algorithm, and obtaining the first image corresponding to the to-be-registered image and the second image corresponding to the reference image further includes: performing torso segmentation on the to-be-registered image and the reference image, obtaining a first torso image corresponding to the first image and a second torso image corresponding to the second image, performing organ segmentation on the first torso image and the second torso image, and obtaining a first organ mask corresponding to the first image and a second organ mask corresponding to the second image.

Performing registration between the first image and the second image based on the preset registration algorithm, and generating the deformation field in which the to-be-registered image is registered with the reference image further includes: performing registration based on the first torso image and the first organ mask, and the second torso image and the second organ mask, and obtaining the deformation field in which the to-be-registered image is registered with the reference image.

In some embodiments, performing image segmentation on the to-be-registered image and the reference image based on the preset segmentation algorithm, and obtaining the first image corresponding to the to-be-registered image and the second image corresponding to the reference image further includes: segmenting a torso and at least one of a head, an upper arm, a lower arm, a thigh, or a lower leg from the to-be-registered image and the reference image, respectively, obtaining a first torso image corresponding to the first image and a second torso image corresponding to the second image, performing organ segmentation on the first torso image and the second torso image, and obtaining a first organ mask corresponding to the first image and a second organ mask corresponding to the second image. The first image and the second image include a corresponding torso and at least one of a corresponding head, a corresponding upper arm, a corresponding lower arm, a corresponding thigh, or a corresponding lower leg, respectively.

Performing registration between the first image and the second image based on the preset registration algorithm, and generating the deformation field in which the to-be-registered image is registered with the reference image further includes: performing registration on at least one of the corresponding head, the corresponding upper arm, the corresponding lower arm, the corresponding thigh, or the corresponding lower leg between the first image and the second image, obtaining a first deformation field, performing registration based on the first torso image and the first organ mask, and the second torso image and the second organ mask, obtaining a second deformation field, fusing the first deformation field with the second deformation field, and obtaining the deformation field in which the to-be-registered image is registered with of the reference image.

In some embodiments, when one of the to-be-registered image or the reference image is the Histoimage with the PET mode, the other one has a mode different from the PET mode.

In some embodiments, when the to-be-registered image is the Histoimage of the PET mode, the reference image includes an image with a Computed Tomography (CT) mode, an image with a Magnetic Resonance Imaging (MRI) mode, or an image with a Single-Photon Emission Computed Tomography (SPECT) mode. Alternatively, when the reference image is the Histoimage of the PET mode, the to-be-registered image includes an image with a CT mode, an image with a MRI mode, or an image with a SPECT mode.

In a second aspect, an image registration system based on a Histoimage is provided, and the image registration system includes: means for acquiring a to-be-registered image and a reference image of an object, and means for performing registration on the to-be-registered image and the reference image. Either or both of the to-be-registered image and the reference image is a Histoimage with a PET mode.

In a third aspect, an electronic device is provided, including a memory, a processor, and a computer program stored in the memory and configured to be executed on the processor. The processor implements the above image registration method based on the Histoimage when executing the computer program.

In a fourth aspect, a computer readable storage medium is provided. A computer program is stored on the computer readable storage medium. When executed by a processor, the computer program implements the above image registration method based on the Histoimage.

Details of one or more embodiments of the present disclosure are set forth in the following accompanying drawings and description. Other features, objectives, and advantages of the present disclosure become obvious with reference to the specification, the accompanying drawings, and the claims.

### BRIEF DESCRIPTION OF THE DRAWINGS

In order to more clearly illustrate the technical solutions in the embodiments of the present disclosure or the related technology, the accompanying drawings to be used in the description of the embodiments or the related technology will be briefly introduced below, and it will be obvious that the accompanying drawings in the following description are only some of the embodiments of the present disclosure, and that, for one skilled in the art, other accompanying drawings can be obtained based on these accompanying drawings without putting in creative labor.

FIG. 1 is a first flowchart of an image registration method based on a Histoimage in an embodiment of the present disclosure.

FIG. 2 is a second flowchart of an image registration method based on a Histoimage in an embodiment of the present disclosure.

FIG. 3 is a third flowchart of an image registration method based on a Histoimage in an embodiment of the present disclosure.

FIG. 4 is a schematic diagram of a target Histoimage in an image registration method based on a Histoimage in an embodiment of the present disclosure.

FIG. 5 is a fourth flowchart of an image registration method based on a Histoimage in an embodiment of the present disclosure.

FIG. 6 is a schematic diagram of an image registration system based on a Histoimage in an embodiment of the present disclosure.

FIG. 7 is a schematic diagram of an electronic device in an embodiment of the present disclosure.

### DETAILED DESCRIPTION OF THE EMBODIMENT

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure, but not all of the embodiments. Based on the embodiments in the present disclosure, all other embodiments obtained by one skilled in the art without making creative labor fall within the scope of protection of the present disclosure.

Unless defined otherwise, technical terms or scientific terms involved in the present disclosure have the same meanings as would generally understood by one skilled in the technical field of the present disclosure. The terms used in the specification of the present disclosure are merely intended to describe specific implementation manners, and are not intended to limit the present disclosure. The term “and/or” as used herein includes any and all combinations of one or more associated listed items.

Image registration may be a process of performing spatial matching on two images with a same mode or different modes. For registration of the two images with the same mode, registration may be performed on images from two scans of a same object at different time. For example, the object may be scanned before and after treatment, respectively, and then registration may be performed. An obtained result may be used to analyze the treatment, and the like. Alternatively, registration may be performed on images from scans of different objects. For example, many technologies may involve a standard image, and then an image of a specific object may be registered with the standard image for analysis. Alternatively, in a same scan of a same object, to implement motion correction and the like, images in different motion phases may need to be registered. For example, in 10 minutes of scan duration, the object does not move within first five minutes, a head of the object moves after a fifth minute, and keeps a moving position until the scan ends. In this case, images at the first five minutes and at last five minutes may need to be reconstructed and registered together to obtain a static image. In addition, technologies such as respiration/heartbeat gating reconstruction may also need to be registered in the same mode. Registration of images with different modes may refer to that a certain geometric transformation is performed on an image to map to another image, so that correlation points in two images may be spatially consistent, and matching of image information with different modes may be implemented more accurately. Images with different modes may be registered in a same manner as the images with the same mode, and a loss function (for example, using mutual information) may be changed. Alternatively, for images with different modes (mode A and mode B), an image with mode A may be transformed into an image with mode B by a generation model, and then the registration of the two images with the same mode may be performed.

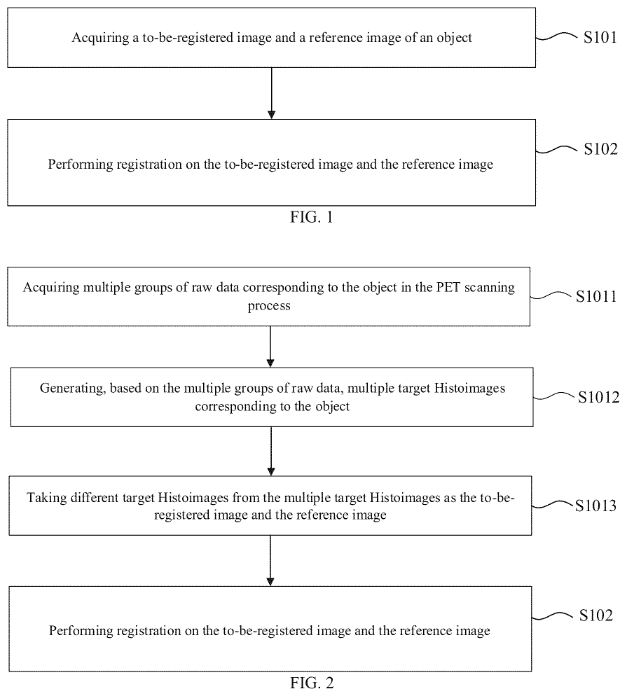

An image registration method based on a Histoimage is provided. Referring to FIG. 1, the image registration method includes step 101 and step 102.

Step 101 includes acquiring a to-be-registered image and a reference image of an object. Either or both of the to-be-registered image and the reference image is a Histoimage with a PET mode.

Step 102 includes performing registration on the to-be-registered image and the reference image.

The object may be a to-be-scanned object that needs to perform medical imaging, such as a human, an animal, or other subject.

The Histoimage may be obtained by raw data of reverse projection. The reverse projection may be implemented by a back-projector. For example, the Histoimage may also refer to a back-projection image obtained, by a weighting function, by weighted back projection of scanning data in a PET scanning process along a response line.

PET is a non-invasive imaging technology commonly used in medical diagnosis and scientific research, and is a nuclear imaging technology (also referred to molecular imaging) that may display vivo metabolic processes. In PET imaging techniques, gamma (γ) photon pairs indirectly emitted by positron emission radionuclides (also referred to radiopharmaceuticals, radionuclides, or radioactive tracers). Before PET scanning, the tracers need to be injected into a vein of organism. A sensitive detector of a PET system may capture a photon emitted after a positron annihilation reaction performed inside a body, and after image reconstruction is performed, a cross-sectional distribution diagram of positron nuclide of the body may be obtained to generate a reconstructed image. However, a process of image reconstruction is time-consuming and has a large calculation amount and poor real-time performance. Image reconstruction may be not suitable in a sensitive scenario.

In a conventional PET image registration method, PET raw data which is directly collected may generally need to be processed to generate a reconstructed image by methods such as FBP or OSEM, resulting in excessive time and calculation overheads, thereby limiting application of a PET technology in a time-sensitive scenario. After the reconstructed image is obtained, image registration may need to be performed, and time spent on registration may be generally less than time spent on reconstruction. Excessive reconstruction time and a calculation threshold may reduce practicality of PET image registration.

The present disclosure proposes a new PET image registration framework, a PET mode image that meets a required precision of registration may be quickly obtained by a back-projection algorithm, i.e., a Histoimage with the PET mode. A plurality of registration algorithms based on iterative optimization or deep learning may be provided for fast registration, thereby ultimately solving a problem of poor real-time performance in PET image registration.

In the image registration method based on the Histoimage in the present embodiments, a Histoimage with good structure information may be quickly generated in real time in a PET scanning process. Either or both of the to-be-registered image and the reference image is a Histoimage with the PET mode. A reconstruction image that requires a relatively long reconstruction time in the related art may be replaced by the Histoimage. Because the Histoimage may have a low computation overhead and a short generation time, a computation cost may be reduced without a conventional image reconstruction process, the real-time performance in image registration of the PET mode may be improved while ensuring registration accuracy of the PET mode image, and computation overhead may be reduced.

In some embodiments, step 101 may include: acquiring raw data corresponding to the object in a PET scanning process, generating, based on the raw data, a target Histoimage corresponding to the object, and taking the target Histoimage as the to-be-registered image or the reference image.

In the present embodiments, the raw data may include one or multiple groups of raw data, and the multiple groups of raw data may include following cases: in one case, multiple sequences may be generated in PET scanning, which may be understood as multiple groups of raw data obtained by PET scanning for multiple times. In another case, the raw data obtained by performing PET scanning once may be divided into several subsets based on time, to obtain multiple groups of raw data.

In some embodiments, referring to FIG. 2, step 101 may include step 1011, step 1012 and step 1013.

Step 1011 may include acquiring multiple groups of raw data corresponding to the object in the PET scanning process.

Step 1012 may include generating, based on the multiple groups of raw data, multiple target Histoimages corresponding to the object.

Step 1013 may include taking different target Histoimages from the multiple target Histoimages as the to-be-registered image and the reference image.

The raw data may include scanning data of a PET list mode or scanning data of a sinogram collected by a scanner during PET scanning on the object, such as a photon coincidence event.

In a case that the raw data is in the PET list mode, the Histoimage may be obtained as follows. A physical location of one or more annihilation points may be determined according to time difference between two photons of a same annihilation event in the scanning data arriving at the detectors at two ends, and the physical location of the one or more annihilation points may be corresponding to pixels of an image domain by weighted accumulation to obtain the Histoimage.

In a PET scanning process, collected raw data may be grouped according to a motion status and a respiration phase of the object, multiple groups of raw data corresponding to the object may be obtained, and each group of raw data may be configured to obtain a target Histoimage correspondingly.

The motion state and the respiration phase of the object may be determined in following manners: a motion signal may be directly collected by external devices, such as a VSM (Vital Signs Monitor) respiration band, an ECG (electrocardiogram), or a tracking camera of head motion. Alternatively, motion detection may be performed based on the PET data to obtain a similar motion signal.

In the image registration method based on the Histoimage in the present embodiments, multiple Histoimage with the PET mode may be registered, and different target Histoimages may be used as the to-be-registered image and the reference image, i.e., both the to-be-registered image and the reference image may be Histoimages with the PET mode.

In some embodiments, referring to FIG. 3, step 101 may include step 1011, step 1012, and step 1014.

Step 1011 may include acquiring multiple groups of raw data corresponding to the object in the PET scanning process.

Step 1012 may include generating, based on the multiple groups of raw data, multiple target Histoimages corresponding to the object.

Step 1014 may include taking any one of the multiple target Histoimages as the to-be-registered image or the reference image.

The image registration method based on the Histoimage in the present embodiments may be further applied to cross-mode registration between a PET mode and another mode.

Exemplarily, an image with the PET mode may be registered to an image with another mode and the target Histoimage may be used as the to-be-registered image, in this case, the reference image may be the image with another mode, and the to-be-registered image may be the Histoimage with the PET mode. Alternatively, the image of another mode may be registered to the image with the PET mode and the target Histoimage may be used as the reference image, in this case, the to-be-registered image may be the image with another mode, and the reference image may be the Histoimage with the PET mode. In other words, when cross-mode registration is performed, one of the to-be-registered image and the reference image may be the Histoimage with the PET mode.

In some embodiments, generating, based on the raw data, the target Histoimage corresponding to the object may further include: generating, based on the raw data, an initial Histoimage corresponding to the object, and preprocessing the initial Histoimage to generate the target Histoimage. The preprocessing may include either or both of correction and denoising

In the present embodiments, the correction or the denoising may improve image quality, so that the Histoimage may have good structure information. Image quality of the target Histoimage may be improved by performing the correction or the denoising on the initial Histoimage.

In some embodiments, preprocessing the initial Histoimage to generate the target Histoimage may further include: performing the correction on the initial Histoimage to generate the target Histoimage. The correction may include at least one of a scattering correction, an attenuation correction, a sensitivity correction, or a random correction.

For the raw data, each response line in the raw data may be projected back to a corresponding specified region to obtain the initial Histoimage, and correction may be performed on the initial Histoimage to obtain the target Histoimage.

A corresponding correction of a physical method may be performed on the initial Histoimage according to a spatial geometric sensitivity of a PET machine and a physical attribute of each photon coincidence event, to obtain the target Histoimage.

Exemplarily, each response line in the raw data may be projected back to the specified region to obtain a point cloud image, and the sensitivity correction and the random correction may be performed on the obtained point cloud image according to a geometric position of each voxel of the point cloud image, to obtain the target Histoimage.

The correction may improve image quality, so that the Histoimage may have good structure information. Image quality of the target Histoimage may be improved by performing the correction on the initial Histoimage.

It should be noted that, when the target Histoimage is generated, the initial Histoimage may be directly used as the target Histoimage without the correction.

In some embodiments, preprocessing the initial Histoimage to generate the target Histoimage may further include: denoising the initial Histoimage by a deep learning network or an image filter. The deep learning network may include a denoising network or a generation network from a Histoimage to a reconstructed image with Ordered Subsets Expectation Maximization.

In the present embodiments, the initial Histoimage may be denoised by the deep learning network or the image filter, so as to improve image quality. The denoising network and the generation network from the Histoimage to the reconstructed image with OSEM may rapidly perform denoising on the initial Histoimage, and the generation network from the Histoimage to the reconstructed image with OSEM may be more efficient than a generation network from raw data to a reconstructed image with OSEM in related art.

It should be noted that, when the target Histoimage is generated, the initial Histoimage may be directly used as the target Histoimage without performing denoising. The correction and the denoising may also be performed at the same time.

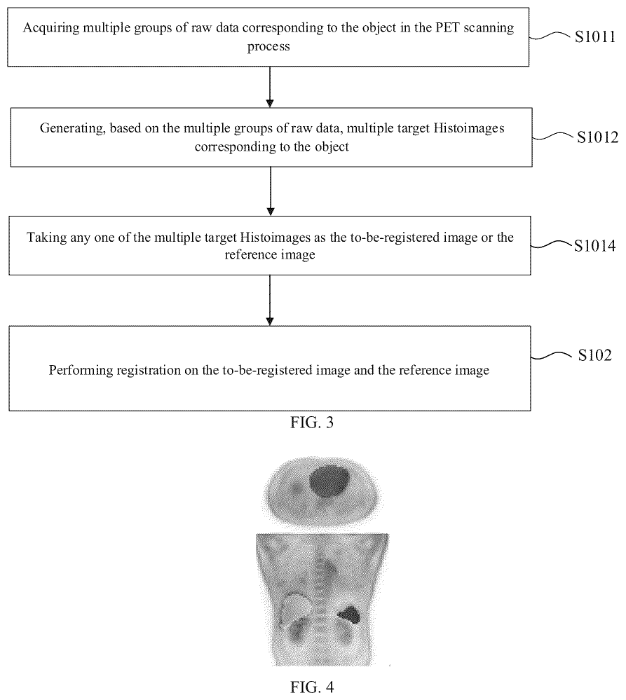

FIG. 4 shows the target Histoimage corresponding to scanning a chest and an abdomen of the object.

The Histoimage with PET mode used in the registration process may be the initial Histoimage obtained by directly performing back projection, or may be the target Histoimage obtained after image quality is improved by physical correction methods such as the sensitivity correction and the random correction after the back projection.

In some embodiments, generating, based on the raw data, the initial Histoimage corresponding to the object may further include: acquiring annihilation events corresponding to the raw data, and performing a back-projection operation on the annihilation events to generate the initial Histoimage.

The annihilation events may be a physical process of mass-energy conversion when a positive electron meets a negative electron, and as a result, two photons (collectively referred to as a photon coincidence event) which are opposite (180 degrees) may be emitted. Each annihilation event in the raw data may be weighted back-projected to a corresponding specified region to generate the initial Histoimage. A specific process may be: accumulating all photon coincidence events in the corresponding specified region one by one to obtain a three-dimensional graph, i.e., the initial Histoimage.

A scanner configured for collecting the raw data may be a scanner with a TOF (time-of-flight) function, or may be a scanner that does not support the TOF function. For the scanner with the TOF function, the specified region may be a TOF bin center, and the TOF function may estimate an occurrence position of the annihilation events by measuring time difference of the two photons arriving at two detectors respectively. Affected by a spatial resolution of the detectors of PET, the occurrence position of the annihilation events may be in a rang, and the TOF bin center may refer to a center position of the range.

For the scanner that does not support the TOF function, the specified region may be a center of LOR (line of response).

In some embodiments, step 102 may further include: performing image segmentation on the to-be-registered image and the reference image, performing image registration on a to-be-registered image obtained after the image segmentation and a reference image obtained after the image segmentation, and generating a deformation field in which the to-be-registered image is registered with the reference image.

In the present embodiments, other unnecessary image element interference may be reduced by image segmentation, and accuracy of the image registration may be improved.

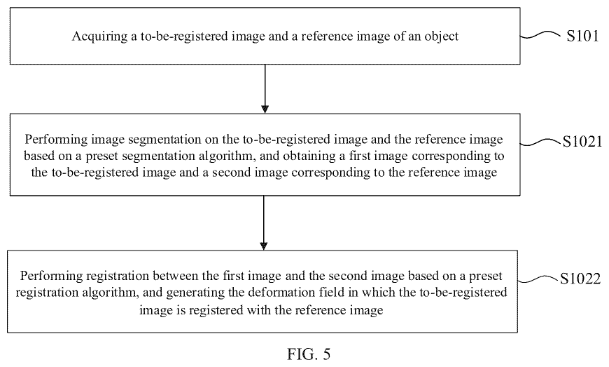

In some embodiments, referring to FIG. 5, step 102 may further include step 1021 and step 1022.

Step 1021 may include performing image segmentation on the to-be-registered image and the reference image based on a preset segmentation algorithm, and obtaining a first image corresponding to the to-be-registered image and a second image corresponding to the reference image.

Step 1022 may include performing registration between the first image and the second image based on a preset registration algorithm, and generating the deformation field in which the to-be-registered image is registered with the reference image.

In some embodiments, image segmentation may be performed according to a location and/or an organ. The image segmentation may include a first image segmentation and/or a second image segmentation. The first image segmentation may be performed according to the location. Exemplarily, the location may include at least one of a head, an upper arm, a lower arm, a thigh, a lower leg, or a torso. The second image segmentation may be performed according to the organ. In some embodiments, organ segmentation may be further performed for the torso. Exemplarily, the organ may include a heart, a lung, a stomach, an intestine, a liver, a spleen, a kidney, and the like.

In some embodiments, performing image segmentation on the to-be-registered image and the reference image based on the preset segmentation algorithm, and obtaining the first image corresponding to the to-be-registered image and the second image corresponding to the reference image may further include: segmenting at least one of a head, an upper arm, a lower arm, a thigh, or a lower leg from the to-be-registered image and the reference image, respectively. The first image and the second image may include at least one of a corresponding head, a corresponding upper arm, a corresponding lower arm, a corresponding thigh, or a corresponding lower leg, respectively.

In the present embodiments, a corresponding deformation field may be obtained by performing registration on at least one of the head, the upper arm, the lower arm, the thigh, or the lower leg that are obtained after image segmentation, respectively.

It should be noted that the segmentation in the first image and the second image may be same or partially different. Exemplarily, when the segmentation in the first image is the same as that in the second image, the first image may include the head, the upper arm, and the lower arm, and the second image may include the head, the upper arm, and the lower arm. When the segmentation in the first image is different from that in the second image, the first image may include the head, the upper arm, and the lower arm, and the second image may include the upper arm, the lower arm, the thigh, and the lower leg.

In some embodiments, performing image segmentation on the to-be-registered image and the reference image based on the preset segmentation algorithm, and obtaining the first image corresponding to the to-be-registered image and the second image corresponding to the reference image may further include: performing torso segmentation on the to-be-registered image and the reference image, obtaining a first torso image corresponding to the first image and a second torso image corresponding to the second image, performing organ segmentation on the first torso image and the second torso image, and obtaining a first organ mask corresponding to the first image and a second organ mask corresponding to the second image.

Performing registration between the first image and the second image based on the preset registration algorithm, and generating the deformation field in which the to-be-registered image is registered with the reference image may further include: performing registration based on the first torso image and the first organ mask, and the second torso image and the second organ mask, and obtaining the deformation field in which the to-be-registered image is registered with the reference image.

In the present embodiments, because organs in the torso are affected by breathing movement and the like, the organs may have many internal deformations, and organ segmentation may be performed on a torso image to obtain a corresponding organ mask, and a corresponding deformation field may be obtained by performing more accurate registration based on the torso image and the organ mask.

Furthermore, when performing registration based on the first torso image and the first organ mask, and the second torso image and the second organ mask, semi-supervised B-spline image registration, deep learning registration, and other registration manners may be applied.

In some embodiments, performing image segmentation on the to-be-registered image and the reference image based on the preset segmentation algorithm, and obtaining the first image corresponding to the to-be-registered image and the second image corresponding to the reference image may further include: segmenting a torso and at least one of a head, an upper arm, a lower arm, a thigh, or a lower leg from the to-be-registered image and the reference image, respectively, obtaining a first torso image corresponding to the first image and a second torso image corresponding to the second image, performing organ segmentation on the first torso image and the second torso image, and obtaining a first organ mask corresponding to the first image and a second organ mask corresponding to the second image. The first image and the second image may include a corresponding torso and at least one of a corresponding head, a corresponding upper arm, a corresponding lower arm, a corresponding thigh, or a corresponding lower leg, respectively.

Performing registration between the first image and the second image based on the preset registration algorithm, and generating the deformation field in which the to-be-registered image is registered with the reference image may further include: performing registration on at least one of the corresponding head, the corresponding upper arm, the corresponding lower arm, the corresponding thigh, or the corresponding lower leg between the first image and the second image, obtaining a first deformation field, performing registration based on the first torso image and the first organ mask, and the second torso image and the second organ mask, obtaining a second deformation field, fusing the first deformation field with the second deformation field, and obtaining the deformation field in which the to-be-registered image is registered with of the reference image.

In the present embodiments, a corresponding first deformation field may be obtained by performing registration on at least one of the head, the upper arm, the lower arm, the thigh, or the lower leg that are obtained after image segmentation, respectively. Organ segmentation may be performed on a torso image to obtain a corresponding organ mask, and a corresponding second deformation field may be obtained by performing more accurate registration based on the torso image and the organ mask. Then, the first deformation field and the second deformation field may be fused to obtain an overall deformation field, thereby further improving registration accuracy.

It should be noted that when a plurality of first deformation fields are obtained by performing registration on at least one of the head, the upper arm, the lower arm, the thigh, or the lower leg that are obtained after image segmentation, the plurality of first deformation fields corresponding to the at least one of the head, the upper arm, the lower arm, the thigh, or the lower leg may be fused first, then fused with the second deformation field, or the plurality of first deformation fields may be fused with the second deformation field directly.

Furthermore, during fusion of deformation fields, following steps may be included:
1. Obtaining deformation fields of different parts.
2. Determining an overlapping region between different parts.
3. For a part that is not overlapped, applying an original deformation field, for the overlapping region, obtaining a final deformation field by a weighted (preset weight) average method, so as to ensure continuity of the deformation field of a connecting part.

In some embodiments, the preset weight used by the weighted average method may be a gradient weight to ensure smooth transition of deformation.

In some embodiments, the first image may include corresponding segmentation information, the second image may include corresponding segmentation information, and the image segmentation may include an organ-level image segmentation, such as a single organ segmentation or a multi-organ segmentation.

Specifically, the segmentation information may be a mask. The multi-organ segmentation may be performed to obtain masks of multiple different organs, and auxiliary registration may be performed by using the mask. The first image corresponding to the to-be-registered image and the second image corresponding to the reference image may be obtained by an image segmentation algorithm. The mask may include information about coordinates of organs in the first image and the second image. In other words, the mask may be corresponding to a boundary range of multiple organs. In the image registration, the mask may play a guiding role in the image registration. Exemplarily, a boundary of an organ mask may be an edge of an organ, and registration of this region can be assisted with the organ mask to obtain a more accurate deformation field.

Exemplarily, a target region of the object may be scanned, and the target region may be a region of the object. Exemplarily, the target region may include some organs or a body part of the object, such as a heart or an abdominal cavity.

When the target region is the abdominal cavity, a stomach, a liver, a spleen, and the like in the abdominal cavity may be segmented respectively by the organ-level image segmentation, to obtain a first image that includes a first stomach mask, a first liver mask, and a first spleen mask, and a second image that includes a second stomach mask, a second liver mask, and a second spleen mask. Based on the preset registration algorithm, registration between the first image and the second image may be assisted by one-to-one corresponding organ masks, and finally a deformation field in which the to-be-registered image is registered with the reference image may be generated, so as to implement the image registration.

The preset segmentation algorithm may include a segmentation algorithm based on deep learning, or a segmentation algorithm based on image processing. The preset segmentation algorithm may apply corresponding segmentation algorithm according to different target regions, thereby ensuring accurate segmentation of all target regions of the object.

Main processing steps based on the preset registration algorithm may include: performing rigid registration on the reference image (or the preprocessed reference image, for example, the second image corresponding to the reference image) and the moving image (or the preprocessed moving image, for example, the first image corresponding to the to-be-registered image), so that locations of the reference image and the moving image roughly match, and then performing registration on the reference image and the moving image by the registration algorithm. In some embodiments, the registration algorithm may include: sampling a series of control points at equal intervals on the reference image, taking locations of all the control points as parameters of a parametric model to represent a continuous deformation field of the entire reference image, defining a target function as difference between the reference image and a registered moving image, and iteratively adjusting all parameter values of the parametric model along a direction of target function descent according to a gradient descent method, until the model converges. The target function may include a similarity index, a regularized index, and a DICE (dice similarity coefficient) between organ-level masks of two images, and a complete deformation field of the images may be obtained by interpolation on the parametric model. In addition to the gradient descent method, a particle swarm optimization algorithm, a simulated annealing algorithm, a Newton method, and the like may also be applied.

The preset registration algorithm may include a conventional registration algorithm based on B (basis)-spline, or may be an optimization algorithm based on other parametric models. The preset registration algorithm may also include a registration algorithm based on deep learning, such as a registration model based on a U-net (a deep-learning image segmentation network) architecture.

When performing rigid registration, a rigid registration algorithm based on 6 degrees of freedom (rotation and displacement) may be applied. Specifically, because segmentation has been performed, masks corresponding to a ROI (region of interest) on the to-be-processed reference image and the moving image may be obtained, so that a center position corresponding to the ROI may be obtained, and center positions of two images may be aligned by translation or rotation, thereby implementing the rigid registration. The ROI may include the head, the upper arm, the lower arm, the thigh, the lower leg, the torso, various organs in the torso, or the like which are obtained during the image segmentation.

In some embodiments, image registration with same mode may be performed on two Histoimages with the PET mode, i.e., both the to-be-registered image and the reference image may be Histoimages with the PET mode.

In some embodiments, when one of the to-be-registered image or the reference image is the Histoimage with the PET mode, the other one has a mode different from the PET mode.

Images with different modes may be images obtained by different imaging principles or different imaging devices, such as CT images, MRI images, PET images, and SPECT images, which are images with different modes.

The image registration method based on the Histoimage in the present embodiments may be applied to a cross-mode registration between the PET mode and another mode. When one of the to-be-registered image or the reference image is the Histoimage with the PET mode, the other one may have a mode different from the PET mode, i.e., another mode. Exemplarily, the image registration method based on the Histoimage may be applied to a cross-mode registration between the Histoimage with the PET mode and images with other modes such as CT, MRI, SPECT, or the like.

In some embodiments, when the to-be-registered image is the Histoimage of the PET mode, the reference image may include an image with a CT mode, an image with a MRI mode, or an image with a SPECT mode.

In the present embodiments, the to-be-registered image may be the Histoimage of the PET mode, the reference image may include the image with the CT mode, the image with the MRI mode, or the image with the SPECT mode, the Histoimage of the PET mode may be registered with the CT mode, the image with the MRI mode, or the image with the SPECT mode, thereby implementing image registration between images with different modes.

In some embodiments, when the reference image is the Histoimage of the PET mode, the to-be-registered image may include an image with a CT mode, an image with a MRI mode, or an image with a SPECT mode.

In the present embodiments, the reference image may be the Histoimage of the PET mode, the to-be-registered image may include the image with the CT mode, the image with the MRI mode, or the image with the SPECT mode.

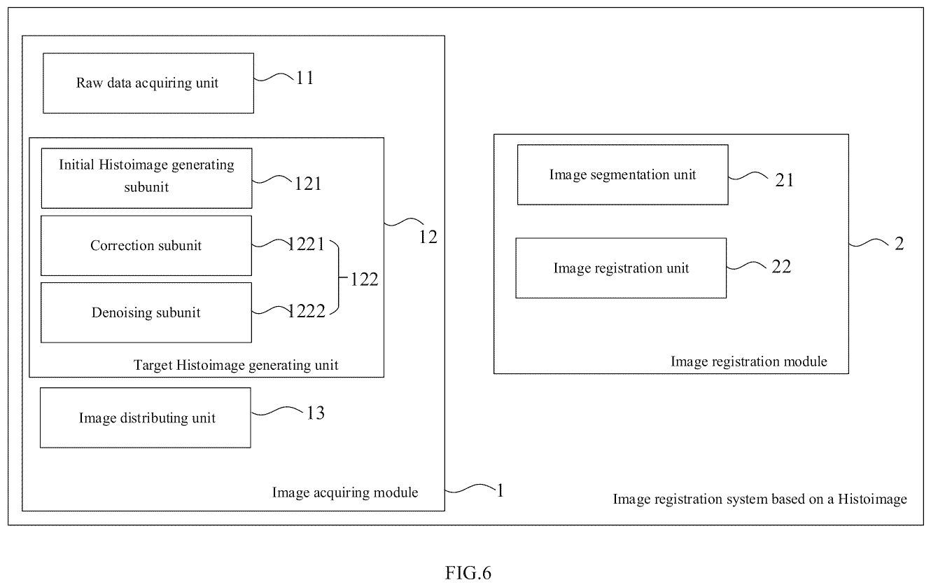

An image registration system based on a Histoimage is provided. The image registration system based on the Histoimage may be corresponding to the above image registration method based on the Histoimage. Referring to FIG. 6, the image registration system based on the Histoimage includes an image acquiring module 1 and an image registration module 2.

The image acquiring module 1 is configured for acquiring a to-be-registered image and a reference image of an object. Either or both of the to-be-registered image and the reference image is a Histoimage with a PET mode.

The image registration module 2 is configured for performing registration on the to-be-registered image and the reference image.

In some embodiments, the image acquiring module 1 may include a raw data acquiring unit 11, a target Histoimage generating unit 12, and an image distributing unit 13.

The raw data acquiring unit 11 is configured for acquiring raw data corresponding to the object in a PET scanning process.

The target Histoimage generating unit 12 is configured for generating, based on the raw data, a target Histoimage corresponding to the object.

The image distributing unit 13 is configured for taking the target Histoimage as the to-be-registered image or the reference image.

In some embodiments, the target Histoimage generating unit 12 may include an initial Histoimage generating subunit 121 and a preprocessing subunit 122.

The initial Histoimage generating subunit 121 is configured for generating, based on the raw data, an initial Histoimage corresponding to the object.

The preprocessing subunit 122 is configured for preprocessing the initial Histoimage to generate the target Histoimage. The preprocessing may include either or both of correction and denoising.

In some embodiments, the preprocessing subunit 122 may further include a correction subunit 1221 configured for performing the correction on the initial Histoimage to generate the target Histoimage.

The correction may include at least one of a scattering correction, an attenuation correction, a sensitivity correction, or a random correction.

In some embodiments, the initial Histoimage generating subunit 121 is further configured for acquiring annihilation events corresponding to the raw data, and performing a back-projection operation on the annihilation events to generate the initial Histoimage.

In some embodiments, the preprocessing subunit 122 may further include a denoising subunit 1222 configured for denoising the initial Histoimage by a deep learning network or an image filter. The deep learning network may include a denoising network or a generation network from a Histoimage to a reconstructed image with OSEM.

In some embodiments, the image registration module 2 is further configured for performing image segmentation on the to-be-registered image and the reference image, performing image registration on a to-be-registered image obtained after the image segmentation and a reference image obtained after the image segmentation, and generating a deformation field in which the to-be-registered image is registered with the reference image.

In some embodiments, the image registration module 2 may further include an image segmentation unit 21 and an image registration unit 22.

The image segmentation unit 21 is configured for performing image segmentation on the to-be-registered image and the reference image based on a preset segmentation algorithm, obtaining a first image corresponding to the to-be-registered image and a second image corresponding to the reference image.

The image registration unit 22 is configured for performing registration between the first image and the second image based on a preset registration algorithm, and generating the deformation field in which the to-be-registered image is registered with the reference image.

In some embodiments, the image segmentation may include an organ-level image segmentation.

In some embodiments, the image segmentation unit 21 is further configured for segmenting at least one of a head, an upper arm, a lower arm, a thigh, or a lower leg from the to-be-registered image and the reference image, respectively. The first image and the second image may include at least one of a corresponding head, a corresponding upper arm, a corresponding lower arm, a corresponding thigh, or a corresponding lower leg, respectively.

In some embodiments, the image segmentation unit 21 is further configured for performing torso segmentation on the to-be-registered image and the reference image, obtaining a first torso image corresponding to the first image and a second torso image corresponding to the second image, performing organ segmentation on the first torso image and the second torso image, and obtaining a first organ mask corresponding to the first image and a second organ mask corresponding to the second image.

The image registration unit 22 is further configured for performing registration based on the first torso image and the first organ mask, and the second torso image and the second organ mask, and obtaining the deformation field in which the to-be-registered image is registered with the reference image.

In some embodiments, the image segmentation unit 21 is further configured for segmenting a torso and at least one of a head, an upper arm, a lower arm, a thigh, or a lower leg from the to-be-registered image and the reference image, respectively, obtaining a first torso image corresponding to the first image and a second torso image corresponding to the second image, performing organ segmentation on the first torso image and the second torso image, and obtaining a first organ mask corresponding to the first image and a second organ mask corresponding to the second image. The first image and the second image include a corresponding torso and at least one of a corresponding head, a corresponding upper arm, a corresponding lower arm, a corresponding thigh, or a corresponding lower leg, respectively.

The image registration unit 22 is further configured for performing registration on at least one of the corresponding head, the corresponding upper arm, the corresponding lower arm, the corresponding thigh, or the corresponding lower leg between the first image and the second image, obtaining a first deformation field, performing registration based on the first torso image and the first organ mask, and the second torso image and the second organ mask, obtaining a second deformation field, fusing the first deformation field with the second deformation field, and obtaining the deformation field in which the to-be-registered image is registered with of the reference image.

In some embodiments, when one of the to-be-registered image or the reference image is the Histoimage with the PET mode, the other one may have a mode different from the PET mode.

In some embodiments, when the to-be-registered image is the Histoimage of the PET mode, the reference image may include an image with a CT mode, an image with a MRI mode, or an image with a SPECT mode.

In some embodiments, when the reference image is the Histoimage of the PET mode, the to-be-registered image may include an image with a CT mode, an image with a MRI mode, or an image with a SPECT mode.

An operation principle of the image registration system based on the Histoimage in the present embodiments may be same as that of the image registration method based on the Histoimage. Details may be not described herein again.

In the image registration system based on the Histoimage in the present embodiments, a Histoimage with good structure information may be quickly generated in real time in a PET scanning process. Either or both of the to-be-registered image and the reference image is a Histoimage with the PET mode. A reconstruction image that requires a relatively long reconstruction time in the related art may be replaced by the Histoimage. Because the Histoimage may have a low computation overhead and a short generation time, a computation cost may be reduced without a conventional image reconstruction process, the real-time performance in image registration of the PET mode may be improved while ensuring registration accuracy of the PET mode image, and computation overhead may be reduced.

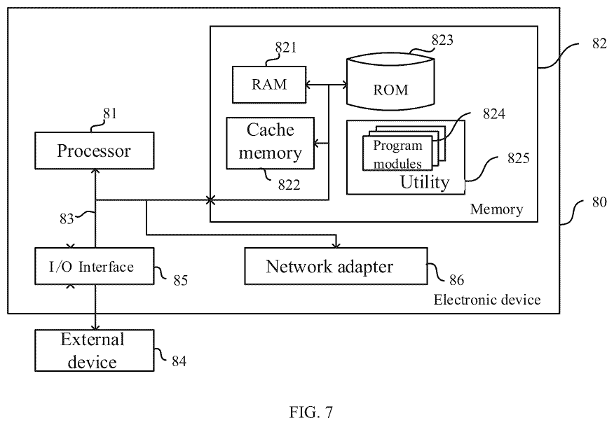

An electronic device is further provided. FIG. 7 is a schematic diagram of an electronic device in the present embodiment. The electronic device includes a memory, a processor, and a computer program stored in the memory and configured to execute on the processor. When executing the program, the processor implements the above image registration method based on the Histoimage. The electronic device 80 shown in FIG. 7 is merely an example, and should not impose any limitation on a function and a use scope of the embodiments of the present disclosure.

Referring to FIG. 7, the electronic device 80 may be represented in a form of a general computing device. Exemplarily, the electronic device 80 may be a server device. Components of the electronic device 80 may include at least one processor 81, at least one memory 82, and a bus 83 connected to different system components (including the memory 82 and the processor 81).

The bus 83 may include a data bus, an address bus, and a control bus.

The memory 82 may include a volatile memory, such as a random-access memory (RAM) 821 and/or a cache memory 822, and may further include a read-only memory (ROM) 823.

The memory 82 may further include a program/utility 825 having a group (at least one) of program modules 824, and the group of the program modules 824 may include an operating system, one or more application programs, other program modules, and program data. Each or a combination of these examples may include an implementation of a network environment.

The processor 81 may execute various functional applications and data processing by executing a computer program stored in the memory 82, such as the image registration method based on the Histoimage in the present disclosure.

The electronic device 80 may also be in communication with one or more external devices 84 (e.g., a keyboard or a pointing device). The communication may be performed via an input/output (I/O) interface 85. In addition, the electronic device 80 may further be in communication with one or more networks (e.g., a local area network (LAN), a wide area network (WAN), and/or a public network, such as the Internet) by a network adapter 86. Referring to FIG. 7, the network adapter 86 may be in communication with other modules of the electronic device 80 by the bus 83. It should be understood that, although not shown in the figures, the electronic device 80 may use other hardware and/or software modules, including microcode, device drives, redundant processors, external disk drive arrays, RAID (disk array) systems, tape drives, data backup storage systems, or the like.

It should be noted that although several units/modules or subunits/modules of the electronic device are mentioned in the foregoing detailed description, such division is merely exemplary and not mandatory. In fact, according to the embodiments of the present disclosure, the features and functions of two or more units/modules described above may be embodied in one unit/module. Conversely, the features and functions of one unit/module described above may be further divided into multiple units/modules to be embodied.

A computer readable storage medium is provided in an embodiment. A computer program is stored on the computer readable storage medium. When executed by a processor, the computer program implements the above image registration method based on the Histoimage.

More specifically, the readable storage medium may include a portable disk, a hard disk, a random-access memory, a read-only memory, a wiper programmable read-only memory, an optical storage device, a magnetic storage device, or any suitable combination of the foregoing.

In a possible embodiment, the present disclosure may further be implemented in a form of a program product, and the program product includes program code. When the program product is executed on a terminal device, the program code is configured to enable the terminal device to perform the steps in the above image registration method based on the Histoimage.

Program code configured to execute the present disclosure may be written in any combination of one or more program design languages, and the program code may be completely executed on a user equipment, partially executed on the user equipment, executed as an independent software package, partially executed on the user equipment and partially executed on the remote device, or completely executed on the remote device.

The various technical features of the above-described embodiments may be combined arbitrarily, and all possible combinations of the various technical features of the above-described embodiments have not been described for the sake of conciseness of description. However, as long as there is no contradiction in the combinations of these technical features, they should be considered to be within the scope of the present specification.

The above-described embodiments express only several embodiments of the present disclosure, which are described in a more specific and detailed manner, but are not to be construed as a limitation on the scope of the present disclosure. For one skilled in the art, several deformations and improvements can be made without departing from the conception of the present disclosure, all of which fall within the scope of protection of the present disclosure. Therefore, the scope of protection of the present disclosure shall be subject to the attached claims.

What is claimed is:

1. An image registration method based on a Histoimage, comprising:
acquiring a to-be-registered image and a reference image of an object, wherein either or both of the to-be-registered image and the reference image is a Histoimage with a Positron Emission Computed Tomography (PET) mode; and
performing registration on the to-be-registered image and the reference image.

2. The image registration method of claim 1, wherein acquiring the to-be-registered image and the reference image of the object further comprises:
acquiring raw data corresponding to the object in a PET scanning process;
generating, based on the raw data, a target Histoimage corresponding to the object; and
taking the target Histoimage as the to-be-registered image or the reference image.

3. The image registration method of claim 2, wherein generating, based on the raw data, the target Histoimage corresponding to the object further comprises:
generating, based on the raw data, an initial Histoimage corresponding to the object; and
preprocessing the initial Histoimage to generate the target Histoimage, wherein the preprocessing comprises either or both of correction and denoising.

4. The image registration method of claim 3, wherein preprocessing the initial Histoimage to generate the target Histoimage further comprises:
performing the correction on the initial Histoimage to generate the target Histoimage, wherein the correction comprises at least one of a scattering correction, an attenuation correction, a sensitivity correction, or a random correction.

5. The image registration method of claim 3, wherein generating, based on the raw data, the initial Histoimage corresponding to the object further comprises:
acquiring annihilation events corresponding to the raw data; and
performing a back-projection operation on the annihilation events to generate the initial Histoimage.

6. The image registration method of claim 3, wherein preprocessing the initial Histoimage to generate the target Histoimage further comprises: denoising the initial Histoimage by a deep learning network or an image filter, wherein the deep learning network comprises a denoising network or a generation network from a Histoimage to a reconstructed image with Ordered Subsets Expectation Maximization.

7. The image registration method of claim 1, wherein performing registration on the to-be-registered image and the reference image further comprises:
performing image segmentation on the to-be-registered image and the reference image, performing image registration on a to-be-registered image obtained after the image segmentation and a reference image obtained after the image segmentation, and generating a deformation field in which the to-be-registered image is registered with the reference image.

8. The image registration method of claim 7, wherein performing image segmentation on the to-be-registered image and the reference image, performing image registration on the to-be-registered image obtained after the image segmentation and the reference image obtained after the image segmentation, and generating the deformation field in which the to-be-registered image is registered with the reference image further comprises:
performing image segmentation on the to-be-registered image and the reference image based on a preset segmentation algorithm, and obtaining a first image corresponding to the to-be-registered image and a second image corresponding to the reference image; and
performing registration between the first image and the second image based on a preset registration algorithm, and generating the deformation field in which the to-be-registered image is registered with the reference image.

9. The image registration method of claim 8, wherein performing image segmentation on the to-be-registered image and the reference image based on the preset segmentation algorithm, and obtaining the first image corresponding to the to-be-registered image and the second image corresponding to the reference image further comprises:
segmenting at least one of a head, an upper arm, a lower arm, a thigh, or a lower leg from the to-be-registered image and the reference image, respectively, wherein the first image and the second image comprise at least one of a corresponding head, a corresponding upper arm, a corresponding lower arm, a corresponding thigh, or a corresponding lower leg, respectively.

10. The image registration method of claim 8, wherein performing image segmentation on the to-be-registered image and the reference image based on the preset segmentation algorithm, and obtaining the first image corresponding to the to-be-registered image and the second image corresponding to the reference image further comprises:
performing torso segmentation on the to-be-registered image and the reference image, obtaining a first torso image corresponding to the first image and a second torso image corresponding to the second image, performing organ segmentation on the first torso image and the second torso image, and obtaining a first organ mask corresponding to the first image and a second organ mask corresponding to the second image; and
performing registration between the first image and the second image based on the preset registration algorithm, and generating the deformation field in which the to-be-registered image is registered with the reference image further comprises:
performing registration based on the first torso image and the first organ mask, and the second torso image and the second organ mask, and obtaining the deformation field in which the to-be-registered image is registered with the reference image.

11. The image registration method of claim 8, wherein performing image segmentation on the to-be-registered image and the reference image based on the preset segmentation algorithm, and obtaining the first image corresponding to the to-be-registered image and the second image corresponding to the reference image further comprises:
segmenting a torso and at least one of a head, an upper arm, a lower arm, a thigh, or a lower leg from the to-be-registered image and the reference image, respectively, obtaining a first torso image corresponding to the first image and a second torso image corresponding to the second image, performing organ segmentation on the first torso image and the second torso image, and obtaining a first organ mask corresponding to the first image and a second organ mask corresponding to the second image, wherein the first image and the second image comprise a corresponding torso and at least one of a corresponding head, a corresponding upper arm, a corresponding lower arm, a corresponding thigh, or a corresponding lower leg, respectively; and
performing registration between the first image and the second image based on the preset registration algorithm, and generating the deformation field in which the to-be-registered image is registered with the reference image further comprises:
performing registration on at least one of the corresponding head, the corresponding upper arm, the corresponding lower arm, the corresponding thigh, or the corresponding lower leg between the first image and the second image, and obtaining a first deformation field;
performing registration based on the first torso image and the first organ mask, and the second torso image and the second organ mask, and obtaining a second deformation field; and
fusing the first deformation field with the second deformation field, and obtaining the deformation field in which the to-be-registered image is registered with of the reference image.

12. The image registration method of claim 1, wherein when one of the to-be-registered image or the reference image is the Histoimage with the PET mode, the other one has a mode different from the PET mode.

13. The image registration method of claim 12, wherein when the to-be-registered image is the Histoimage of the PET mode, the reference image comprises an image with a Computed Tomography (CT) mode, an image with a Magnetic Resonance Imaging (MRI) mode, or an image with a Single-Photon Emission Computed Tomography (SPECT) mode; or
when the reference image is the Histoimage of the PET mode, the to-be-registered image comprises an image with a CT mode, an image with a MRI mode, or an image with a SPECT mode.

14. An electronic device, comprising a memory, a processor, and a computer program stored in the memory and configured to be executed on the processor, wherein the processor implements the image registration method based on the Histoimage of claim 1 when executing the computer program.

15. The electronic device of claim 14, wherein acquiring the to-be-registered image and the reference image of the object further comprises:
acquiring raw data corresponding to the object in a Positron Emission Computed Tomography (PET) scanning process;
generating, based on the raw data, a target Histoimage corresponding to the object; and
taking the target Histoimage as the to-be-registered image or the reference image.

16. The electronic device of claim 15, wherein generating, based on the raw data, a target Histoimage corresponding to the object further comprises:
generating, based on the raw data, an initial Histoimage corresponding to the object; and
preprocessing the initial Histoimage to generate the target Histoimage, wherein the preprocessing comprises either or both of correction and denoising.

17. The electronic device of claim 16, wherein preprocessing the initial Histoimage to generate the target Histoimage further comprises:
performing the correction on the initial Histoimage to generate the target Histoimage, wherein the correction comprises at least one of a scattering correction, an attenuation correction, a sensitivity correction, or a random correction.

18. The electronic device of claim 16, wherein generating, based on the raw data, the initial Histoimage corresponding to the object further comprises:
acquiring annihilation events corresponding to the raw data; and
performing a back-projection operation on the annihilation events to generate the initial Histoimage.

19. The electronic device of claim 16, wherein preprocessing the initial Histoimage to generate the target Histoimage further comprises: denoising the initial Histoimage by a deep learning network or an image filter, wherein the deep learning network comprises a denoising network or a generation network from a Histoimage to a reconstructed image with Ordered Subsets Expectation Maximization.

20. A computer readable storage medium on which a computer program is stored, wherein the computer program is executed by a processor to implement the image registration method based on the Histoimage of claim 1.
